(19) United States
(12) Patent Application Publication
(10) Pub. No.: US 2015/0234369 A1
(43) Pub. Date: Aug. 20, 2015

(54) UNIFIED CONTROLLER FOR INTEGRATED LIGHTING, SHADING AND THERMOSTAT CONTROL

(71) Applicant: KONINKLIJKE PHILIPS N.V., Eindhoven (NL)

(72) Inventors: Yao-Jung Wen, Concord, CA (US); Dagnachew Birru, Yorktown Heights, NY (US)

(21) Appl. No.: 14/429,518

(22) PCT Filed: Sep. 10, 2013
(86) PCT No.: PCT/IB2013/058415

§ 371 Date: Mar. 19, 2015

Related U.S. Application Data
(60) Provisional application No. 61/703,987, filed on Sep. 21, 2012.

(51) Int. Cl. G05B 15/02; H05B 37/02; E06B 9/68; F24F 11/00

(52) U.S. Cl. CPC G05B 15/02; F24F 11/006; H05B 37/0218; E06B 9/68; E06B 2009/6809

(57) ABSTRACT

A controller (100) for control of lighting (13), shades (12), and thermostat (11) is disclosed. The controller comprises at least one comfort regulator (1) for providing an indication for setting at least one rule (2, 5); at least a controller interface (10) for controlling at least one of thermostat, lighting and shades; at least a sensor interface (18) for receiving sensory information respective of at least one of heating, ventilating and air conditioning (HVAC) (17), occupancy (16), lighting and shading from a photosensor (15); wherein the at least controller interface responsive of receiving the sensory information and based on the at least one rule controls the thermostat, the lighting and the shades to an optimal position.

The invention generally relates to the control of lighting, shading and temperature, and more specifically to a controller having a flexible architecture to control the same.

It has been recognized that building elements are interrelated, for example, electric lights and window shades are concurrently used to create a comfortable lighting condition, but in the meantime they both generate or emit heat that affects the load on the heating, ventilating and air conditioning (HVAC) systems. In order to deliver a comfortable visual and thermal environment in the most energy-efficient manner it is important to account for the interrelationship between a building's elements using an integrated and holistic approach.

Currently, visual comfort and thermal comfort are, in practice, separately controlled. Moreover, even electric lights and shades are controlled separately. Electric lights may be controlled by wall switches or, in the best case scenario, are automatically dimmed or turned off in response to daylight and/or occupancy status. Shading systems, such as venetian blinds and roller shades, are largely controlled by the occupants, for example, by pulling strings. Even modern motorized shading systems are still mostly manually controlled through wall panels. Thermal comfort is specified as a temperature set-point by the occupants on a wall-mounted thermostat, and some thermostats are capable of connecting to centralized building automation systems (BAS) for supervisory controls, such as night-time setback.

There have been attempts to promote unified lighting and HVAC controls for better energy management, but their focus has been on the whole-building level integration of BAS or energy management and control systems (EMCS). This level of integration provides only centralized access to multiple systems for facility managers to implement high-level supervisory controls and automated energy efficiency measures. Therefore, on top of the building-level supervisory controls, a lower-level, e.g., zone-level, integration is necessary to actually deliver optimal visual and thermal comfort to occupants, taking into account different types of use, orientation, location, etc., in each zone.

A few attempts have been made to consider integrated control of visual and thermal comfort for energy efficiency. For example, A. Guillemin and N. Morel, “An Innovative Lighting Controller Integrated in a Self-adaptive Building Control System,” Energy and Buildings, vol. 33 (5), 2001, pp. 477-487 (hereinafter “GUILEMIN”), and \check{Z}. Kristl, M. Ko\check{s}ir, M. Trobec-Lah and A. Krainer, “Fuzzy Control System for Thermal and Visual Comfort in Building,” Renewable Energy, vol. 33 (4), 2008, pp. 694-702 (hereinafter “KRISTL”), are primarily focused on the development and implementation of intelligent algorithms, the systems of which were integrated in a very customized laboratory setting. While addressing the interdependencies between building lighting and thermal elements, most controllers considered a subset of the three systems, e.g. shades and heater in KRISTL, and lights and HVAC in J. V. Miller, “Energy Saving Integrated Lighting and HVAC System,” U.S. Patent Application Publication No. 2009/0032604 (hereinafter “Miller”). Moreover, the controllers may only work for very specific types of systems or need to tap into lower-level system components, such as the upward heat-emitting lamp fixtures and HVAC air duct dampers in Miller. In addition, the integrated controller may adjust the lighting condition to preserve energy, but this can sacrifice the visual comfort of a person occupying the space, for example, due to glare.

Therefore, in recognition of the deficiencies of the prior art, it would be advantageous to overcome the lack of a controller that can implement automated zone-based control of lights, shades and temperature set-points in a practical, integrated fashion.

Certain embodiments disclosed herein include a controller that provides controls for lighting, shades and a thermostat. The controller comprises at least one comfort regulator for providing an indication for the setting of at least one rule; at least a controller interface for controlling at least one of a thermostat, lighting and shades; at least a sensor interface for receiving sensory information respective of at least one of heating, ventilating and air conditioning (HVAC), lighting, and occupancy, wherein the at least controller interface responsive of receiving the sensory information and based on the at least one rule controls the thermostat, the lighting and the shades to an optimal position.

Certain embodiments disclosed herein also include a method for the control of lighting, shades and thermostat. The method comprises providing an indication for setting at least one rule from a comfort regulator of a controller for the control of lighting, shades and thermostat; receiving sensory information respective of at least one of heating, ventilating and air conditioning (HVAC), occupancy, lighting and shading; and generating control signals to control the lighting, shades, and thermostat respective of the sensory information and the at least one rule.

Certain embodiments disclosed herein also include a controller for the control of a lighting system, a shading system, and a thermostat. The controller comprises a set-point decision engine for determining setting of at least a horizontal illuminance set-point, a vertical illuminance set-point, and a thermostat set-point, wherein the determination is performed based on a rule-based setting process; a lighting load balancing engine for determining a set of settings for the lighting and the shading, wherein the set of settings meets at least the set-points received, and the set-point decision engine meets at least the horizontal illuminance set-point and the vertical illuminance set-point, wherein the set of settings is determined in order to minimize glare and power consumption by the lighting system; and a driver connector for controlling the thermostat system, the lighting, and the shading system in a controlled zone based in part on the thermostat set-point, and the set of settings is determined by the lighting load balancing engine.

The subject matter that is regarded as the invention is particularly pointed out and distinctly claimed in the claims at the conclusion of the specification. The foregoing and other features and advantages of the invention will be apparent from the following detailed description taken in conjunction with the accompanying drawings.

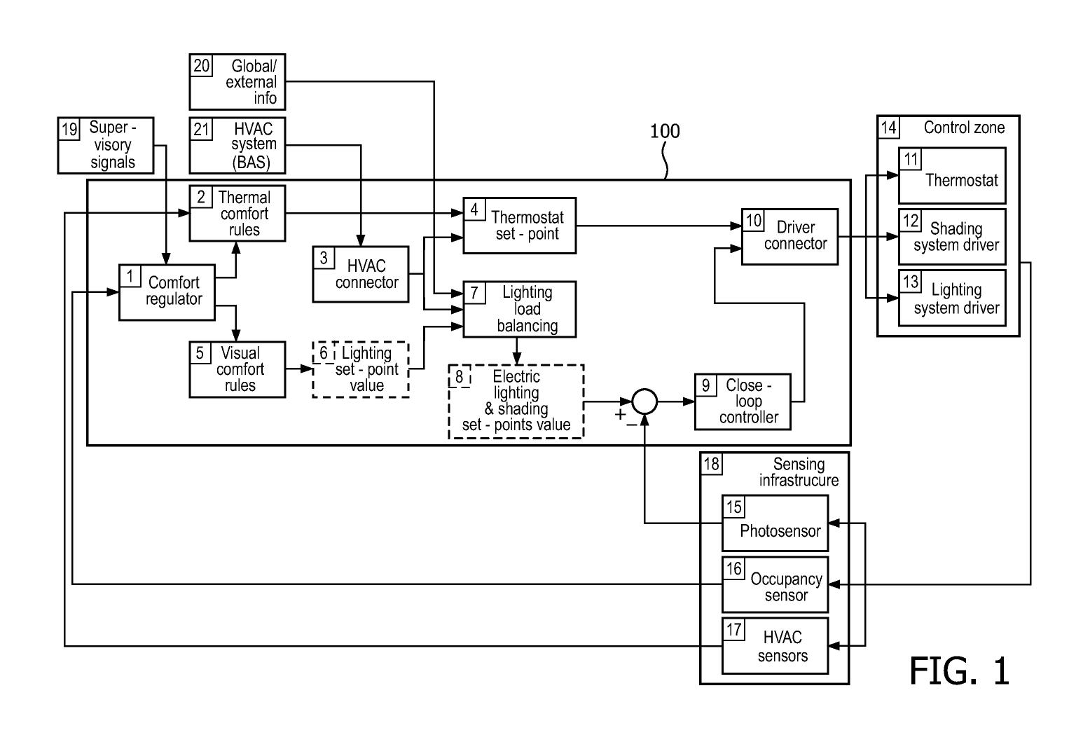

FIG. 1 is a schematic diagram of an integrated controller according to an embodiment of the invention;

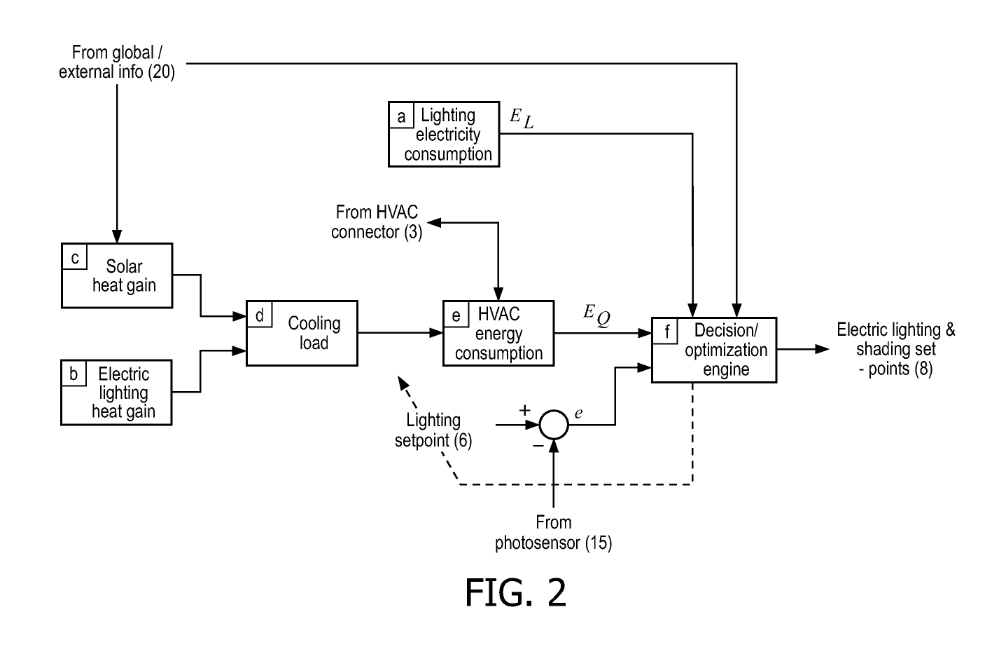

FIG. 2 is a schematic block diagram of the lighting load balancing for the integrated controller;

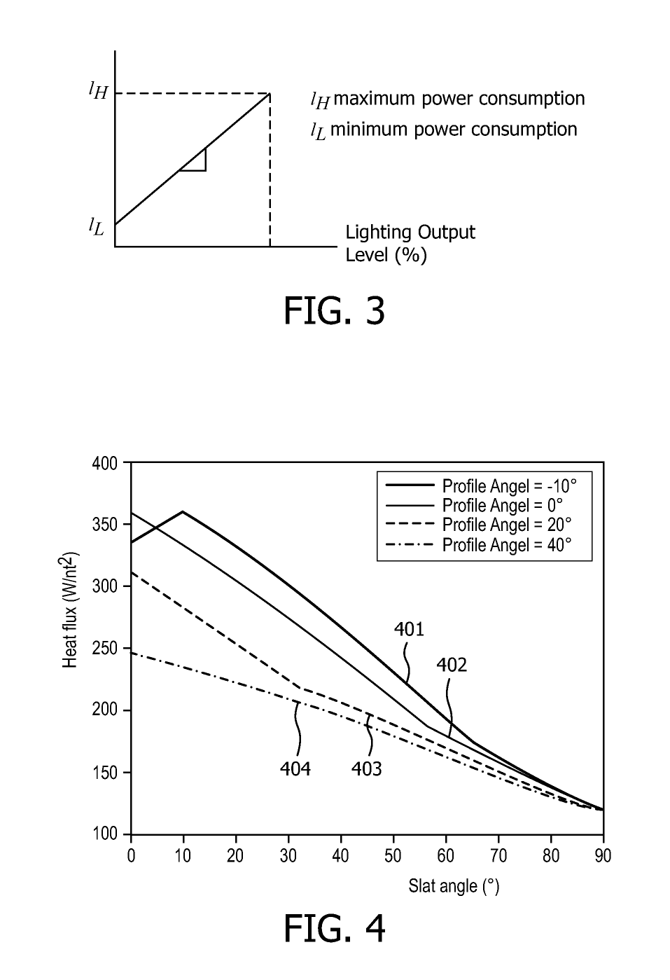

FIG. 3 is a graph of the relationship between the electric light output level and electric power;

FIG. 4 is a graph of the solar heat gain model of a complex fenestration system;

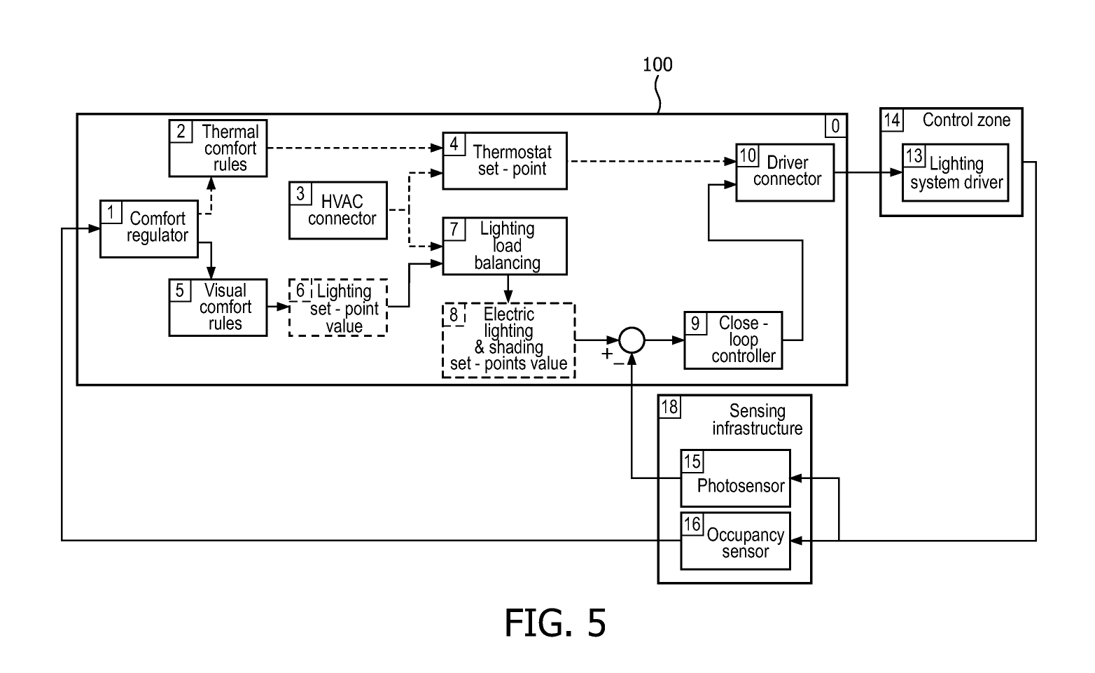

FIG. 5 is a schematic block diagram of the integrated controller using only the electric lighting control feature;

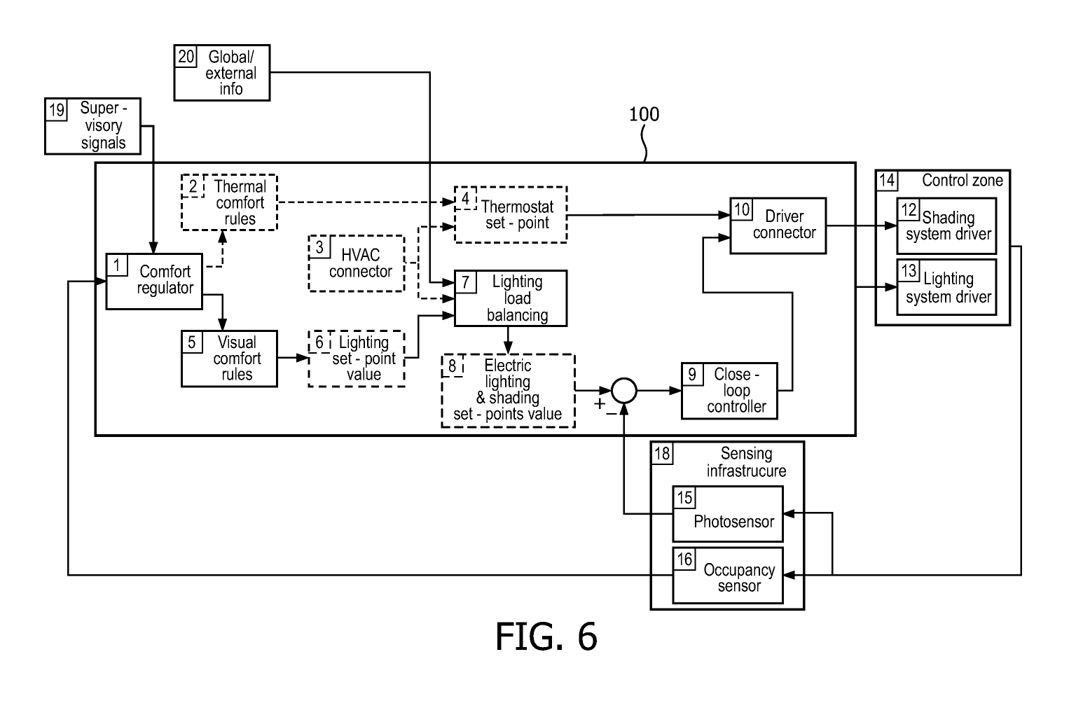

FIG. 6 is a schematic block diagram of the integrated controller using the electric lighting control feature and the shading control feature;

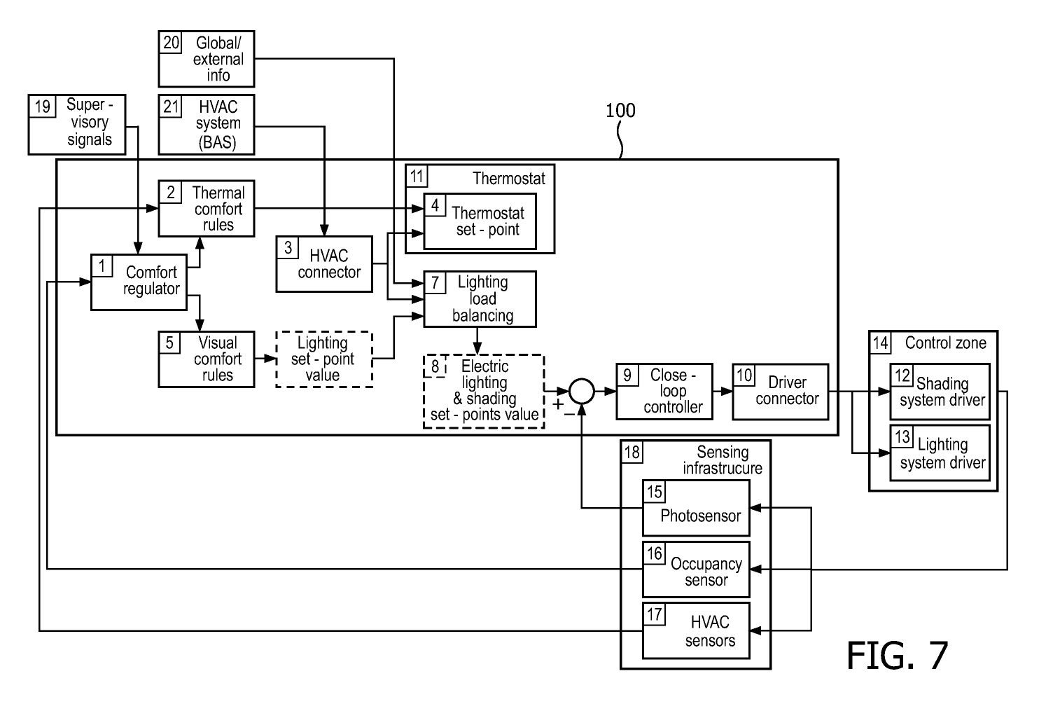

FIG. 7 is a schematic block diagram of the thermostat-integrated controller according to an embodiment of the invention;

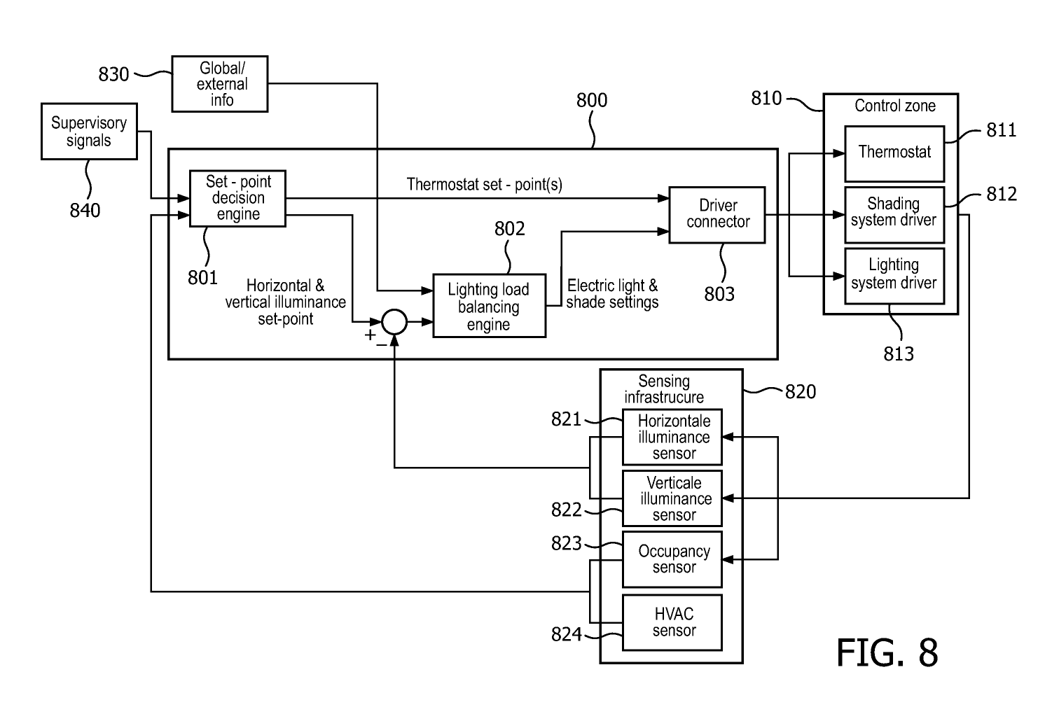

FIG. 8 is a schematic block diagram of an integrated controller using a vertical photosensor according to another embodiment; and

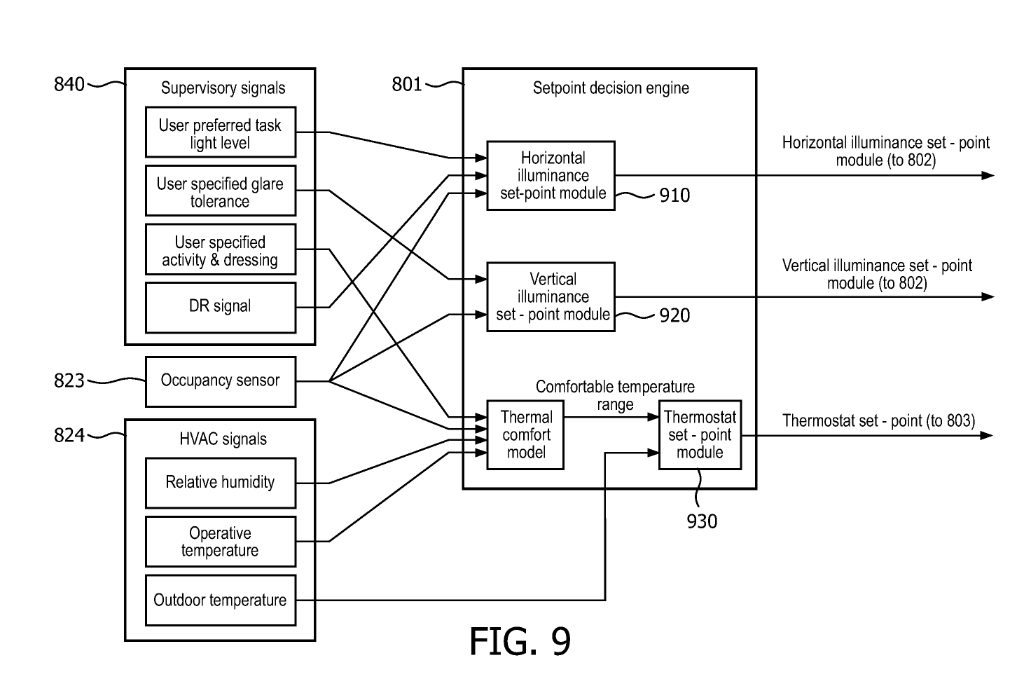

FIG. 9 is a schematic block diagram of a set-point decision engine utilized in the integrated controller of FIG. 8.

It is important to note that the embodiments disclosed are only examples of the many advantageous uses of the innovative techniques herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

FIG. 1 shows an exemplary and non-limiting block diagram of an integrated controller 100 according to an embodiment of the invention. The integrated controller 100 is composed of components (1) through (10) and sensors (15) through (17) of the sensing infrastructure (18), as well as supervisory signals, such as external information and connections (19) through (21), which are the inputs to the controller 100 for making optimal control decisions. The controller 100 actuates the connected system hardware of a zone (14), including the thermostat (11), the shading system driver (12) and the lighting system driver (13), through the driver connector (10). The detailed implementation and alternatives of each component are discussed in greater detail herein below.

The comfort regulator (1) receives information from the occupancy sensor (16) and supervisory signals (19), e.g., demand response (DR) signals, user overrides, etc., to determine the importance of user preference and comfort, i.e., the tradeoffs between preference/comfort and energy. For example, under normal operation, the comfort regulator may determine that comfort has the highest priority. However, in the absence of occupants as reported by the occupancy sensor, the comfort regulator may consider comfort a much less important parameter than an attempt to generate more energy savings. When receiving a supervisory signal indicating a DR event, the comfort regulator puts a slightly less emphasis on comfort in order to shed a certain amount of load. As an example implementation, the comfort regulator may simply be a set of user preferences having, for instance, a 10-point “importance scale” representing the relative importance of levels of comfort. Each input, i.e., occupancy status, DR signal, user override, etc., corresponds to a different amount of increment or decrement on the 10-point importance scale. The resulting comfort importance value on the scale, along with user specified preferences, are then fed into the thermal comfort rules (2) and visual comfort rules (5).

The thermal comfort rules (2) are essentially a module for calculating a range of possible temperature set-points, which are determined by the importance of comfort, i.e., output of (1), and real-time sensor measurements (17). The thermal comfort rules (2) can be implemented in various ways. One example implementation is a set of IF-THEN rules. For instance, a rule can be “IF comfort regulator index is greater than 9, THEN air temperature is in the range of 21-24° C.”

The thermal comfort rules (2) can also incorporate a sophisticated thermal comfort model, for example, Fanger's predicted mean vote (PMV) model. With real-time HVAC sensor measurements, e.g., mean radiant temperature and relative humidity, a range of air temperature set-points is calculated that results in PMV<±0.7, which corresponds to 85% satisfaction. The number range of ±0.7 in the example may change according to the comfort importance value from the comfort regulator (1).

The HVAC connector (3) is connected to the BAS or energy management and control system (EMCS) (21) that is in charge of the HVAC system operation. The main function of the HVAC connector is to obtain the operation mode information (cooling/heating) of the HVAC system. In one embodiment, in order to communicate with BAS or EMCS, the HVAC connector interfaces with standard communication protocols used by the linked BAS or EMCS, such as, but not limited to, BACnet, LonWorks, and the like. Other information can also be exchanged between the HVAC connector and BAS if needed.

The thermostat set-point module (4) selects the best set-point within the range of possible temperature set-points generated by the thermal comfort rules (2) that results in maximum energy efficiency. The decision is based on the HVAC operation information obtained through the HVAC connector (3). For example, if the thermal comfort rules (2) generated a temperature range of 21-24° C., and from the HVAC connector (3) it is learned that the HVAC system is operating in cooling mode, then 24° C. will be selected by the thermostat set-point module (4) for a minimum cooling requirement, the information of which is then sent to the thermostat (11) through the driver connector (10). One example of implementing the thermostat set-point module (4) is a set of IF-THEN rules, such as:
“IF HVAC is in cooling mode, THEN select the upper-bound temperature as the set-point
IF HVAC is in heating mode, THEN select the lower-bound temperature as the set-point.”

The visual comfort rules (5) is essentially a module for determining the proper overall light level, which is the combination of electric light and daylight, i.e., lighting set-point (6), with respect to user preferences and different levels of comfort importance as specified by the comfort regulator (1). One example for implementing the visual comfort rules (5) is to consider only task illuminance with an IF-THEN rule set. For instance, the following exception of a rule set can be used for normal operation and a DR event responsive of a DR signal, respectively, when the preferred light level is 500 lux.
“IF comfort regulator index is greater than 9, THEN set lighting set-point to 500 lux.”
“IF comfort regulator index is between 8 and 9, THEN set lighting set-point to 450 lux.”
   The lighting set-point (6) simply represents the target overall lighting set-point as determined from the visual comfort rules set by the visual comfort rules (5). In another embodiment, described in detail below with reference to FIGS. 8 and 9, the lighting set-point may also represent a comfort glare level.

The lighting load balancing module (7) is embedded with intelligence to determine the optimal electric light level and daylight shading, for example, determining window shade height, as well as the slat angle for venetian blinds of windows treatments, that meets the set-point specified in the lighting set-point (6) with minimum overall energy consumption. In one embodiment, the lighting load balancing module (7) incorporates the HVAC operating mode from the HVAC connector (3) and global/external information (20), e.g. date, solar position and irradiance, etc., to generate the electric lighting and shading set-points (8).

One example for a possible lighting load balancing implementation is to solve the following optimization problem in (eq 1), where E_{L} is the electric lighting load, E_{Q} is the additional cooling load from electric lights and fenestration solar heat gain, m is a weighting factor, e is the error between the resulting light level and the set-point in the lighting set-point (6), and k denotes the associated time step.

minimize E_{L}(k)+mE_{Q}(k)

subject to e_{L}≦e(k)≦e_{H} (eq 1)

FIG. 2 is an exemplary and non-limiting schematic block diagram of the lighting load balancing module (7) of the integrated controller 100. FIG. 2 illustrates an instance of detailed realization of the lighting load balancing module (7), which can be comprised, for example, of six building elements, namely blocks (a) through (f). A lighting electricity consumption block (a) estimates the power consumption from lighting electricity, which is linearly proportional to the electric light output level as shown in exemplary and non-limiting FIG. 3. An electric lighting heat gain block (b) estimates the lighting heat gain from the light bulbs and fixtures. Electric lighting heat gain is proportional to the lighting power, which, as shown in FIG. 3, has a linear relationship to the light output level.

Both blocks (a) and (b) may be more accurately estimated if the lighting system driver (13) provides a real-time power measurement feedback. A solar heat gain block (c) estimates the admitted solar heat gain in the space. This can be realized in various ways. For example, in one embodiment, a mathematical model describing the heat transfer mechanism of the fenestration system can be established for predicting solar heat gain with known solar irradiances from the global/external information channel (20). The solar irradiance readings can be measured or be obtained from nearby weather stations.

FIG. 4 shows an exemplary and non-limiting solar heat flux (heat gain from a unit fenestration area) with respect to different slat angles, calculated from one such model with an interior venetian blind. Alternatively, the solar heat gain can be roughly measured using a pyranometer placed on the inside of the fenestration system. As illustrated in FIG. 4, curves 401, 402, 403, and 404 represent the measured flux with respect to different profile angles set to −10°, 0°, 20°, and 40° respectively. The slat angle is the angle of the slat that may move between an essentially horizontal position and an essentially vertical position. The profile angle is the sun incident angle projected onto the plane perpendicular to window surface, which determines the altitude of direct sun relative to the fenestration system. Returning to FIG. 2, a cooling load block (d) converts the lighting and solar heat gains into cooling load. Part of the heat gains, the convective portion, immediately appears as cooling load while the other part, the radiant portion, will be absorbed by the building's thermal mass and re-radiated as a cooling load at a later time. One way to describe this mechanism is a first order difference equation (eq. 2), where k represents the time step, Q is the cooling load, q is the heat gain, and the coefficients (w₁, v₀, v₁) are determined according to the building's characteristics, such as envelope construction, floor mass, air circulation, luminaire type, and so on.

Q(k)=w₁Q(k−1)+v₀q(k)+v₁q(k−1) (eq 2)

A HVAC energy consumption block (e) characterizes the energy required to remove the cooling load as determined by the cooling load block (d), which depends on the efficiency and overall load of the HVAC system. One example of realization by the cooling load block (d) is a constant approximation of the coefficient of performance (COP), e.g., the ratio of the cooling load to the energy required to remove it. Typically, COP is not a constant and varies with the HVAC operating condition. Therefore, a sophisticated way to realize this block is to incorporate the HVAC efficiency curves with the real-time operating conditions through the connection to the HVAC system.

A decision/optimization engine Block (f) makes the control decisions on electric light level and shade settings based on the estimation and prediction of energy consumption from blocks (a) and (e). This is where an optimization/control strategy shown in (eq 1) may be deployed, or any other optimization/control strategy could be utilized.

Returning to FIG. 1, the electric lighting and shading set-points (8) are comprised of the set-point decisions from the electric lighting system and the shading system. The two set-points are the reference inputs to the closed-loop controller (9).

The closed-loop controller (9) is part of the inner system-level control loop which is comprised of the electric lighting and shading set-points (8), a driver connector (10), a shading system driver (12), a lighting system driver (13), and a photosensor (15). This inner loop ensures that electric lights and window treatments installed in one or more windows, including the light output level, shade height and slat angle for venetian blinds, are properly actuated to meet all the corresponding reference set-points (8). The controller (9) can be implemented using any traditional automatic control techniques, such as a proportional-integral-derivative (PID) control.

The driver connector (10) includes built-in hardware for the controller 100 to interface with the drivers of physical systems in the control zone, including the thermostat (11), shading system driver (12) and lighting system driver (13). The driver connector (10) translates the actuation commands from the thermostat set-point module (4) and the closed loop controller (9) into recognizable signals for each of the hardware drivers. For example, the signals to and from the control zone (14) may be 0-10V or may be digital addressable lighting interface (DALI) signals for dimmable ballasts. In addition, the connections can also be wireless using standardized communication protocols such as ZigBee.

The control zone (14) represents one or more systems connected to and controlled by the controller 100. In one embodiment, the control zone (14) includes a thermostat (11), a shading system driver (12) and a lighting system driver (13). The systems of the control zone (14) can be provided by different manufacturers capable of establishing connections with the controller's driver connector (10), for example, by using standardized protocols.

The sensors (15), (16) and (17) form a sensing infrastructure (18) of the controller 100. The photosensor (15) may contain ceiling-mounted photosensors for measuring task illuminances and/or vertical illuminance sensors for glare detection purposes. The occupancy sensor (16) detects motions in the space. In one embodiment, discussed in detail below, the photosensor (15) may include two photosensors installed horizontally and vertically relative to the surface. The HVAC sensors (17) can be an air temperature sensor, a globe temperature sensor that measures the combined effects of air and radiant temperature, and/or a humidity sensor depending on how each component in the controller is implemented. It should be noted that the sensors (15), (16) and (17) are not limited to being used only by the components indicated by the arrows in FIG. 1, but can also be shared among all the components in the controller as needed. The correspondence between the sensors and controller components is merely one realization instance.

The supervisory signals block (19) is a channel for overriding the controller 100. The signals may be in the form of user preferences, user overrides, building manager's instructions, DR signals, and so on. The supervisory signals may be categorized into two types: absolute settings and event signals. The absolute settings may be a set of desired lighting and thermal conditions specified by an occupant or the building manager, which will be taken into account by the comfort regulator (1), thermal comfort rules (2), and visual comfort rules (5) in the process of determining the optimal set-points. The event signals can be DR signals or temporary overriding signals that essentially instruct the comfort regulator (1) to change the relative importance of comfort and user preferences.

The global/external information (20) provides an additional information element to the controller 100. The information can be date, solar position, solar irradiance, outdoor temperature, etc., depending on the exact lighting load balancing module (7) implementation. For example, solar position and irradiance can be used to estimate solar heat gain and the corresponding cooling load, and the outdoor temperature may be used to infer HVAC operating mode (cooling/heating), which may also be directly available from the HVAC system through HVAC connector (3).

In one embodiment, the HVAC system (BAS) (21) is the entity in charge of HVAC system operation. The controller 100 obtains the HVAC operating mode (cooling/heating) information from (21) through the HVAC connector (3). The BAS (21) and the HVAC connector (3) can be optional as the operation mode can be reasonably deduced from the outdoor temperature if it is available as one of the external information elements (20).

The layered architecture of the controller 100 disclosed herein, as well as the components therein, do not have to be installed and/or connected all at once. Components may be added or subtracted, for example, in a multiphase retrofitting project allowing for flexibility in terms of budgeting and scheduling. In one embodiment, the controller 100 can be packaged as a lighting control solution, which contains the complete controller in the box, along with a lighting system driver (13), photosensors (15) and occupancy sensors (16). Such a configuration is shown in the exemplary and non-limiting FIG. 5. Specifically, the components of FIG. 1 not shown, i.e., the thermal comfort rules (2), HVAC connector (3), and thermostat set-point module (4) of the controller 100 may be present, but functionally these components are inactive or otherwise automatically bypassed. In this configuration, the lighting load balancing module (7) and electric lighting and shading set-points (8) omit any consideration of the shades. This combination, as a standalone lighting system, is adequate for performing typical automatic lighting control and management strategies, such as occupancy sensing, daylight harvesting, and so on.

When the shades are upgraded to a motorized shading system (12) installed in one or more windows and connected to the controller 100 through the driver connector (10), as shown in the exemplary and non-limiting FIG. 6, the controller 100 can automatically perform integrated control of electric lights and shades for better comfort and energy savings. The performance can be further enhanced if the global/external information (20) is available and connected. After being connected to a smart grid infrastructure, the DR signals in the form of supervisory signals (19) can be fed into the controller, thereby allowing the controller to participate in DR programs, for example to automatically shed loads in an optimal manner.

Likewise, when the controller (100) is connected to the HVAC system, i.e. BAS (21), thermostat (11) and the corresponding sensors (17), the controller (100) can perform integrated control of electric lights, shades and thermostat for optimal visual and thermal comfort, as well as energy efficiency.

Another alternative embodiment is to integrate the thermostat (11) into the controller (100) as shown in exemplary and non-limiting FIG. 7. Specifically, according to this embodiment the controller (100) completely replaces the thermostat of a zone, eliminating the need to comply with the communication protocol used by other thermostats for connectivity. This configuration can be packaged as a standalone thermostat, and, based on the same layered architecture, lighting and shading systems can be added later for full-functioning integrated control. In addition, this configuration may also be packaged as a thermostat/lighting controller combo with temperature set-point control and occupancy- and/or daylight-responsive lighting controls as basic functionalities. A shading system can be connected separately for complete integrated control.

FIG. 8 shows an exemplary and non-limiting block diagram of an integrated controller 800 according to another embodiment. The integrated controller 800 also provides the integration of both control access points and an automatic decision making process for optimal comfort as well as energy efficiency at the zone level. In addition, the integrated controller 800 improves visual comfort by explicitly detecting and avoiding discomfort from glare.

The integrated controller 800 is composed of a set-point decision engine 801, a lighting load balancing engine 802, and a driver connector 803. The controller 800 receives inputs from the sensing infrastructure 820, the external global information 830, and the supervisory signals 840 in order to make optimal control decisions. The controller 800 actuates the connected system hardware of a controlled zone 810, including a thermostat 811, a shading system driver 812, and a lighting system driver 813, through the driver connector 803. The detailed implementation of each of the components in the controlled zone 810 is discussed in greater detail herein above. It should be noted that although not shown in FIG. 8, the controller 800 may include additional components, such as the HVAC connector (3) and the closed-loop controller (9). In one embodiment, these components are integrated in the driver connector 803.

The global/external information 830 is utilized by the controller 800 to make optimal control decisions. The information can be, for example, a date, solar position, solar irradiance, HAVC operation mode, and so on. The load balancing engine 802 can be utilized for one or more of the pieces of the information 830. The supervisory signals 840 serve as the channel for overriding or providing additional information to the controller 800. The signals may be in the form of user preferences, user overrides, instructions from an administrator (e.g., building maintenance manager), energy usage curtailment requests (DR signals), and so on. The driver connector 803 is the gateway between the calculated electric light, shade and thermostat set-points and the actual drivers of the respective systems 811-813 in the controlled zone 810. The operation of the driver controller 803 is discussed in detail above with respect to FIG. 1.

According to this embodiment, the controller 800 sets the lighting condition based on a horizontal illuminance set-point and a vertical illuminance set-point. With this aim, the sensing infrastructure 820 includes a horizontal illuminance photosensor 821 and a vertical illuminance photosensor 822, in addition to the occupancy sensor 823 and HVAC sensor 824 (sensors 823 and 824 are discussed in detail above). In this particular embodiment, the vertical illuminance photosensor 822 is added to the sensing infrastructure 820 to enable the controller 800 to dynamically adjust the lighting in the room based on the received vertical illuminance information to avoid discomfort glare. The vertical illuminance photosensor 822 is mounted vertically facing the window at a location to measure the vertical illuminance at the occupant's eye level. This measured level provides an indication of discomfort glare possibility. The horizontal illuminance photosensor 821 measures the illuminance level on a horizontal surface (e.g., a desk) and can be mounted in the ceiling facing the floor. The adjustment is performed to determine the optimal settings for electric lights, shades/blinds and a thermostat.

Specifically, the set-point decision engine 801 is set to determine the following three set-points: the horizontal illuminance set-point, the vertical illuminance set-point, and the thermostat set-point. The horizontal illuminance set-point specifies the task light level suitable for the task being performed by the occupants. The vertical illuminance set-point serves as a threshold, beyond which discomfort glare may occur. The thermostat set-point is used to regulate the indoor air temperature at a comfortable level. The set-points are determined based on one or more of the following inputs: occupancy status from the occupancy sensor 823, the current zone thermal condition from the HVAC sensors 824, and user-specified preference as well as energy usage curtailment level from supervisory signals 840. The resulting thermostat set-point is fed directly to the driver connector 803 to adjust the set-point of the thermostat 811 in the controlled zone 810. The horizontal and vertical illuminance set-points serve as the references for the lighting load balancing engine 802 to determine the optimal electric light and shade/blind settings to provide an ample lighting in the space (room) while minimizing the glare and power consumption.

A block diagram of the set-point decision engine 801 according to one embodiment is shown in the exemplary and non-limiting FIG. 9. The set-point decision engine 801 includes a horizontal illuminance set-point module 910 for setting a horizontal illuminance set-point, a vertical illuminance set-point module 920 for setting vertical illuminance set-point, and a thermostat set-point module 930 for setting the thermostat set-point.

The horizontal illuminance set-point is determined, in part, on the basis of the user's preference and is further adjusted according to an occupancy status received from the sensor 823 (FIG. 8), and an energy usage curtailment level, e.g., a DR event, to account for energy efficiency. The user's preference and the curtailment level are received as part of the supervisory signals 840. In one embodiment, the module 910 sets the horizontal illuminance set-point using a rule-based setting process (algorithm). A non-limiting example for such a rule-based may be:
A user specified horizontal task illuminance is 500 lux, i.e., Iref=500 lux.
IF Occupancy Status is Occupied AND Energy Curtailment Level is None, THEN Iset_h=Iref;
IF Occupancy Status is Occupied AND Energy Curtailment Level is Low, THEN Ise_h=0.9Iref;
IF Occupancy Status is Occupied AND Energy Curtailment Level is High, THEN Iset_h=0.7Iref;
IF Occupancy Status is Unoccupied, THEN Iset_h=Ignore;

Iset_h is the horizontal illuminance set-point that the lighting load balancing engine 802 tries to maintain. In one embodiment, the set point decision engine 801 can be implemented to comply with the established energy usage curtailment protocol, such as OpenADR, and the like.

The module 920 sets the vertical illuminance set-point based, in part, on the calibrated value that corresponds to the border line of discomfort from glare. The calibrated value represents the mapping from the vertical illuminance at the measured location to that at the eye level of a person. This value can further be adjusted to the user's glare perception received through the supervisory signals (840). The importance of limiting the actual vertical illuminance below the set-point is further based on the status of occupancy received from the sensor 823. In one embodiment, the module 920 sets the vertical illuminance set-point using a rule-based setting process (algorithm). A non-limiting example for such a rule-based may be:
A calibrated (default) vertical illuminance level is 2000 lux, i.e. Gref=2000 lux;
The default setting may further lowered by the user to Gref=1800 lux;
IF Occupancy Status is Occupied, THEN Iset_v=Gref;
IF Occupancy Status is Unoccupied, THEN Iset_v=Ignore;

Iset_v is the vertical illuminance set-point. The lighting load balancing engine 802 ensures that the measured level of the vertical lighting does not exceed the level of Iset_v. The operation of the thermostat set-point module 930 is the same as thermostat set-point module (4) discussed in detail above.

Referring back to FIG. 8, the lighting load balancing engine 802 calculates a set of settings for electric lighting and shading systems that will meet the set-points received from the set-point decision engine 801, while minimizing the related lighting and HVAC energy loads. Possible settings for lighting system driver 813 include powering the lights on or off, and dimming the illuminate level. The setting for shading system driver 812 includes setting the heights of shades or setting the deployment/retraction level as well as slat angle, in the case of blinds. The lighting load balancing engine 802 ensures that the resulting settings meet the set-points in a closed-loop manner by constantly comparing the real-time sensor measurements from the horizontal and vertical illuminance sensors to their respective set-points. As noted above, global or external information 830, such as a date, solar position and irradiance, and HVAC operation mode from an administrator can also be provided to the lighting load balancing engine 802 for determining the optimal output settings.

The lighting load balancing engine 802 implements a solution to an optimization problem in order to set the control of electric lights and motorized shades. In one exemplary embodiment, the optimization problem can be defined as follows:

minimize E_{L}(k)+mE_{Q}(k)

subject to ε_{L}≦(Iₛₑₜ_{_{—}}ₕ(k)−Iₛₑₙₛₒᵣ_{_{—}}ₕ(k))≦ε_{H}

Iₛₑₜ_{_{—}}ᵥ(k)≦Iₛₑₙₛₒᵣ_{_{—}}ᵥ(k) (eq 3)

The objective of the optimization problem in (eq 3) is to minimize the energy consumption. The first equation (E_{L}(k)+mE_{Q}(k)) is the index of the energy consumption, where E_{L} is the electric lighting load, E_{Q} is the additional cooling load from electric lights and fenestration solar heat gain, m is a weighting factor, and k denotes the associated time step. E_{L} and E_{Q} may be mathematical models that incorporate the real-time information from the global/external information 830.

The equations (ε_{L}≦(Iset_h(k)−Isensor_h(k)≦ε_{H}) and (Iset_v(k)≦Isensor_v(k)) are the constraints in the optimization problem formulation that regulates the horizontal task light level and vertical illuminance level, respectively, to meet the set-points Iset_h and Iset_v set-points for the horizontal and vertical illuminance, respectively. The Isensor_h and Isensor_v are the sensor readings from the horizontal illuminance sensor 821 and the vertical illuminance sensor 822, respectively. That is, the equation (ε_{L}≦(Iset_h(k)−Isensor_h(k)≦ε_{H}) compares and regulates the difference between the horizontal illuminance measurement and set-point within a small tolerable range (_{L} and _{H}) for a satisfactory task light level. The equation (Iset_v(k)<Isensor_v(k)) ensures that the measured vertical illuminance does not exceed the vertical illuminance set-point beyond which discomfort glare may occur. This can be achieved by controlling the shading system driver 813 in such a way that the shade/blind does not open enough to let in daylight due to the consideration of potential discomfort from glare and the aim of comfortable “task lighting”, i.e., to write or work on computer.

The various embodiments disclosed herein can be implemented as hardware, firmware, software or any combination thereof. Moreover, the software is preferably implemented as an application program tangibly embodied on a program storage unit, a non-transitory computer readable medium, or a non-transitory machine-readable storage medium that can be in a form of a digital circuit, an analog circuit, a magnetic medium, or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. A method for controlling light, shades and thermostat, comprising:
determining relative importance of user preference or comfort, and energy consumption based on sensory information from at least one of a heating, ventilating and air conditioning (HVAC) sensor, an occupancy sensor, a lighting and shading photosensor and supervisory signals;
setting at least one rule from a comfort regulator of a controller for controlling lighting, shades and thermostat based on determined relative importance;
and
generating control signals by a driver connector to control the lighting, shades, and thermostat respective of the sensory information and the at least one rule.

2. The method of claim 1, wherein the at least one rule is any one of: a rule for thermal comfort and a rule for visual comfort, wherein the rule for thermal comfort includes a range of possible temperature set-points, and wherein the rule for visual comfort determines a proper overall light level.

3. The method of claim 2, wherein calculating the range of set-points is performed respective of determination of importance of the thermal comfort.

4. The method of claim 3, wherein the proper overall light level is further determined based on importance of the visual comfort.

5. A computer readable medium having stored thereon instructions for causing one or more controllers to execute the method according to claim 1.

6. A controller for controlling lighting, shades and thermostat, comprising:
at least one comfort regulator for determining a relative importance of user preference or comfort, and energy consumption;
setting at least one rule for controlling lighting, shades and thermostat based on determined relative importance;
at least one controller interface for controlling at least one of thermostat, lighting and shades;
at least one sensor interface for receiving sensory information from at least one of a heating, ventilating and air conditioning (HVAC) sensor, an occupancy sensor, a lighting and shading photosensor;
wherein the at least one comfort regulator determines the relative importance based on said sensory information and supervisory signals, and wherein the at least one controller interface responsive of receiving the sensory information and based on the at least one rule controls the thermostat, the lighting and the shades to an optimal position.

7. The controller of claim 6, wherein the at least one comfort regulator determines a value of the at least one rule using sensory information received from an occupancy sensor, the value of the at least one rule is determined at least to balance between comfort preferences of a user and a minimal energy consumption.

8. The controller of claim 6, further comprising a thermal comfort module connected to at least one comfort regulator, wherein the thermal comfort is configured to hold at least one rule for thermal comfort.

9. The controller of claim 8, further comprising a thermostat set-point module connected to the thermal comfort module and configured to select a set-point within the range of possible temperature set-points generated by the thermal comfort module that results in a minimal energy consumption.

10. The controller of claim 6, further comprising a visual comfort module connected to the at least one comfort regulator and configured to hold at least one rule for visual comfort.

11. The controller of claim 10, wherein the visual comfort module sets and computes a value of one or more set-points for overall lighting in a space based on the at least one rule for the visual comfort.

12. The controller of claim 10, further comprising a lighting load balancing module connected to a HVAC connector, wherein the lighting load balancing module is configured to determine at least one set point value for an optimal electric light level and an optimal external light level.

13. The controller of claim 12, further comprising:
a closed-loop controller configured to receive the electric lighting and shading set-points as a reference input and a feedback input from the at least one photosensor; and
a driver connector connected to a thermostat set-point module and the closed-loop controller, the driver connector being connected to least one of: a thermostat, a shading system driver, and a lighting system driver in the controlled zone.

14. A controller for controlling a lighting system driver, a shading system driver, and a thermostat, comprising:
a set-point decision engine for determining settings for at least a horizontal illuminance set-point, a vertical illuminance set-point, and a thermostat set-point, wherein the determination is performed based on a rule-based setting process;
a lighting load balancing engine for determining a set of settings for the lighting and the shading, wherein the set of settings meets at least the set-points received and the set-point decision engine meets at least the horizontal illuminance set-point and the vertical illuminance set-point, wherein the set of settings is determined in order to minimize glare and power consumption by the lighting system; and
a driver connector for controlling the thermostat, the lighting system driver, and the shading system driver in a controlled zone based in part on the thermostat set-point, and the set of settings determined by the lighting load balancing engine.

15. The controller of claim 14, wherein the lighting load balancing engine receives sensory information from a horizontal illuminance sensor and a vertical illuminance sensor, wherein the set of settings is determined responsive to the received sensory information.
